(19) United States
(12) Patent Application Publication
(10) Pub. No.: US 2007/0100703 A1
(43) Pub. Date: May 3, 2007

(54) Selling system

(76) Inventor: Tatsuo Noda, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,880

(22) Filed: Oct. 27, 2005

(51) Int. Cl. G06Q 30/00

(52) U.S. Cl. 705/26

(57) ABSTRACT

A selling system adopting the invention includes a storage medium storing information on a product to be purchased as purchase information, and a selling device that reads the purchase information from the storage medium and provides the product according to that purchase information. Thus, if purchase information stored on the storage medium is read by the selling device, then it is not necessary for the user to select the product that he or she would like to purchase using buttons, etc. That is, users who purchase a fixed product can purchase that target product simply by inserting their storage medium.

### FIELD OF THE INVENTION

The present invention relates to selling systems

### BACKGROUND INFORMATION

Recently, the unattended selling of electronic information property such as electronic newspapers through selling devices installed in train stations, etc., has been proposed. For example, with conventional selling systems, electronic newspapers are wirelessly transmitted to selling devices installed in train stations from information processing devices installed in newspaper publishing companies. A user inserts a storage medium, such as an IC card, into the selling device and manipulates buttons to select an electronic newspaper that he or she would like to purchase. The electronic newspaper thus selected is written to the IC card, and by reproducing the IC card with a reproducing device such as an electronic pocketbook, that electronic newspaper can be viewed. Payment can be made with cash as well as prepaid cards and credit cards, for example.

Although numerous newspaper publishing companies exist, normally a person reads only the newspaper of a specific publishing company. With the above conventional selling system, however, the user is forced to manipulate buttons, etc., to select a newspaper that he or she would like to purchase from among the electronic newspapers of a plurality of newspaper publishing companies. This operation is annoying for users who have a newspaper that they read regularly.

The present invention was proposed in light of the foregoing conventional matters, and it is an object thereof to provide a selling system that allows a target product to be purchased easily.

### SUMMARY OF THE INVENTION

The invention employs the following means to achieve the foregoing object.

A selling system adopting the invention includes a storage medium storing information on a product to be purchased as purchase information, and a selling device that reads the purchase information from the storage medium and provides the product according to that purchase information. Thus, if the purchase information stored on the storage medium is read by the selling device, then it is not necessary for the user to select the product that he or she would like to purchase using buttons, etc. That is, users who purchase a fixed product can purchase the target product simply by inserting their storage medium.

It should be noted that it is also possible to store a purchase record of the product on the storage medium, and for the selling device to restrict the sale of the product based on that purchase record. Further, if the product is a medicinal item or leisure item, then the invention is useful in restricting the number of a same product that is sold in a fixed period of time.

With the invention, purchase information stored on the storage medium is read by the selling device, and thus it is not necessary for the user to select the product that he or she would like to purchase using buttons, etc. That is, users who purchase a fixed product can purchase the target product simply by inserting their storage medium.

### BRIEF DESCRIPTION OF THE DRAWINGS

FIG. 1 is a schematic structural diagram of a selling system that employs the invention.

FIG. 2 is a schematic structural diagram of a selling device that employs the invention.

FIG. 3 is a flowchart showing the operation of a selling system that employs the invention.

FIG. 4 is a flowchart showing the operation of a selling system that employs the invention.

### DETAILED DESCRIPTION OF THE PREFERRED EMBODIMENTS

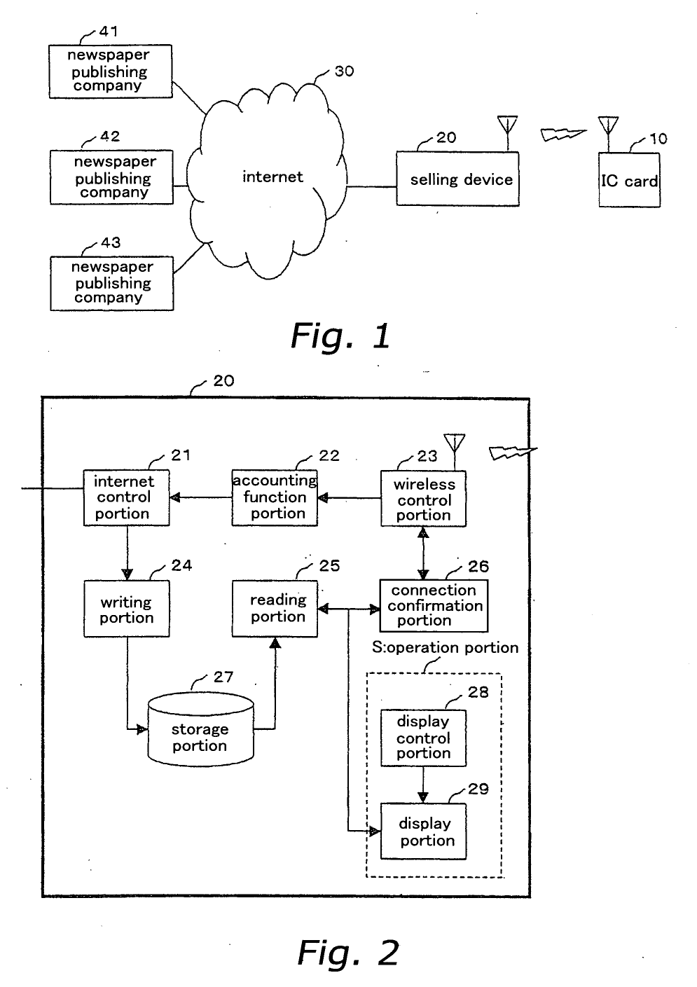

Embodiments of the invention are described in detail below according to the drawings. FIG. 1 is a schematic structural diagram of a selling system that has adopted the invention.

A plurality of newspaper publishing companies 41 to 43 and a selling device 20 are connected via an internet 30, and the selling device 20 can wirelessly communicate with a storage medium such as an IC card 10. This system is similar to the conventional selling system discussed above in that electronic newspapers are delivered to the selling device 20 from the newspaper publishing companies 41 to 43.

FIG. 2 is a schematic structural drawing of the selling device 20.

An internet control portion 21 is a means for sending and receiving information to and from the newspaper publishing companies 41 to 43 via the internet 30. A writing portion 24 is a means for writing information to a storage portion 27 such as a hard disk, and a reading portion 25 is a means for reading information from the storage portion 27. A wireless control portion 23 is a means for wirelessly communicating with the IC card 10, and a connection confirmation portion 26 is a means for confirming that connection. An operation portion S is a means for receiving instructions from the user, and is made of a display portion 29 such as a touch panel and a display control portion 28 for controlling the display of the display portion 29. An accounting function portion 22 is a means for performing accounting when a product has been purchased, and this accounting information is transmitted to an administrative server (not shown) installed in each of the newspaper publishing companies 41 to 43 via the internet 30.

On the other hand, the information of the product to be purchased is stored on the IC card 10 as purchase information. For example, a user who has purchased an electronic newspaper that is published by the newspaper publishing company 42 will have an identifier of the electronic newspaper that is published by the newspaper publishing company 42 recorded onto his or her IC card 10 as purchase information. When an electronic newspaper has been purchased, a record of that purchase is recorded onto the IC card 10 by the selling device 20.

The configuration and the operation of a selling system that employs the invention are described below.

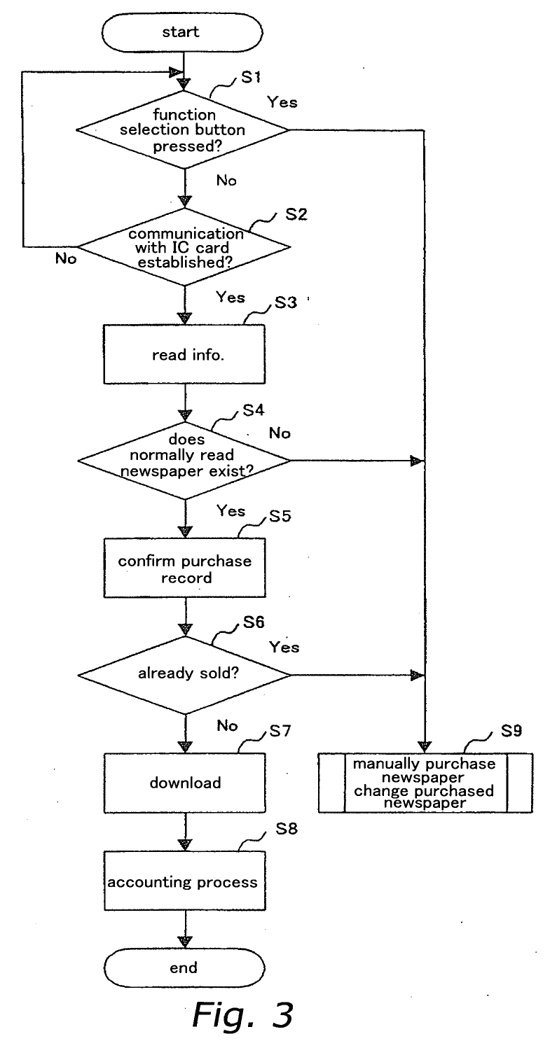

First, a message urging the user to insert his or her IC card 10, together with function selection buttons for providing other functions, such as “1. Manual Purchase” and “2. Change Purchased Newspaper,” are displayed on the display portion 29. When the IC card 10 is inserted into (or placed on) the selling device 20 without first pushing one of these function selection buttons, the wireless control portion 23 establishes a connection with the IC card 10 (FIG. 3, steps S1 and S2).

When a connection with the IC card 10 has been established, the purchase information and the purchase record are read from the IC card 10 via the wireless control portion 23 and delivered to the reading portion 25. The reading portion 25 determines whether the electronic newspaper of the purchase information exists in the storage portion 27 (FIG. 3, steps S3 and S4). If it is determined that the electronic newspaper exists, then the purchase record is confirmed to determine whether that electronic newspaper has already been purchased (FIG. 3, steps S5 and S6). If it is determined here that it has not yet been purchased, then that electronic newspaper is read from the storage portion 27.

The electronic newspaper thus read is downloaded onto the IC card 10 together with an updated purchase record via the wireless control portion 23 (FIG. 3, step S7). Information necessary for accounting purposes is delivered to the accounting function portion 22 from the wireless control portion 23 and accounting is executed (FIG. 3, step S8), and that accounting information is sent to the administrative servers (not shown) installed in the newspaper publishing companies 41 to 43 via the internet control portion 21 and the internet 30. When payment is made using cash or a prepaid card, it is not absolutely necessary for the accounting information to be sent to the administrative servers.

On the other hand, if one of the function selection buttons has been pushed (FIG. 3, step 1: Yes), if the electronic newspaper of the purchase information does not exist in the storage portion 27 (FIG. 3, step 4: Yes), or if the electronic newspaper has already been purchased (FIG. 3, step 6: Yes), then, as described below, separate functions are provided.

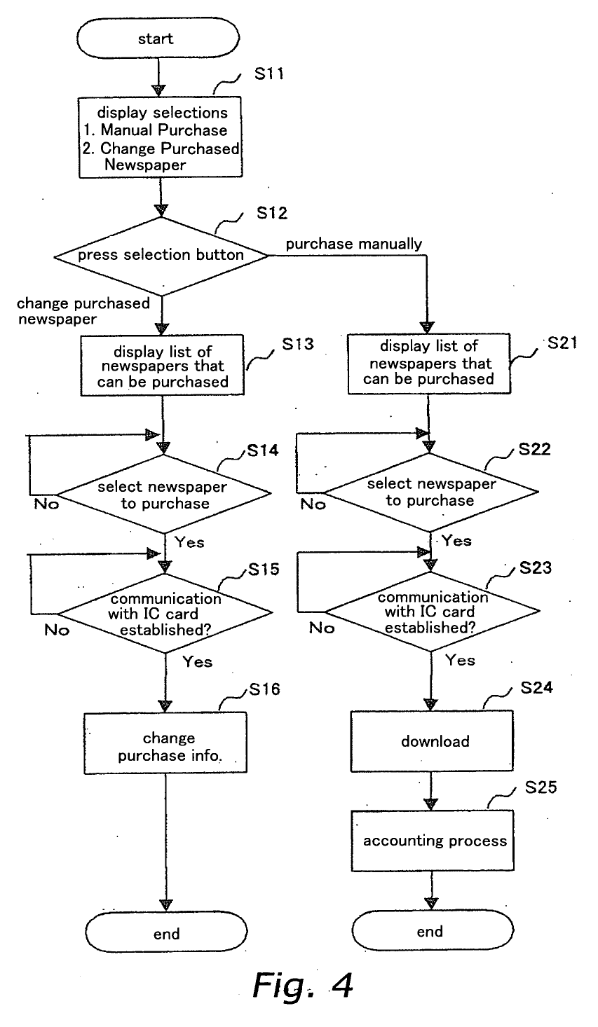

That is, when the “1. Manual Purchase” function selection button displayed on the display portion 29 is pressed (FIG. 4, steps S11 and S12), it becomes possible to manually purchase an electronic newspaper like in conventional selling systems. Here, a list of the newspapers that can be purchased is displayed on the display portion 29 (FIG. 4, step S21), and when one item is selected from this list (FIG. 4, step S22), that newspaper is downloaded onto the IC card 10 (FIG. 4, steps S23 and S24). The accounting process (FIG. 4, step S25) is then performed as before.

When the “2. Change Purchased Newspaper” function selection button displayed on the display portion 29 is pressed (FIG. 4, steps S11 and S12), it becomes possible to manually change the purchase information stored on the IC card 10. Here, a list of the newspapers that can be purchased is displayed on the display portion 29 (FIG. 4, step S13), and when one newspaper is selected from this list (FIG. 4, step S14), the purchase information stored on the IC card 10 is erased and the identifier of the electronic newspaper that has been selected here is written to the IC card 10 as new purchase information (FIG. 4, steps S15 and S16).

Thus, with this invention, the purchase information stored on the IC card is read by the selling device and therefore it is not necessary for the user to select the electronic newspaper that he or she would like to purchase using buttons, etc. That is, users who read a particular newspaper can purchase that electronic newspaper simply by inserting their IC card.

Further, with this invention, a purchase record of the electronic newspaper is stored on the IC card, and thus it is possible for sales of the product to be restricted by selling device based on that purchase record. The above description pertains to a configuration for preventing a product from being purchased multiple times, using the sale of electronic information property in the form of an electronic newspaper as an example. However, if the product is a medicinal item or leisure item, then the invention also can be useful for restricting the number of a same product that is purchased in a fixed period of time, such as two pills per day in the case of medicine or one pack per day in the case of cigarettes. That is, it is preferable that the manner in which sales are restricted is changed depending on the nature of the product.

The invention, like the conventional technology, also allows a target product to be purchased manually and allows purchase information stored on the IC card to be changed manually. By doing this, there is a decreased likelihood that a product other than the target product will be purchased inadvertently.

It should be noted that although not referred to specifically in the above description, it is also possible for a user's personal information to be stored on the IC card. This would make it possible to make available products that are suited for the user. For example, if the IC card stores information on the user's profession, then it becomes possible to provide an electronic newspaper that includes only those articles that have particular relevance to that profession.

The invention allows information to be communicated between a storage medium and a selling device, and can be adopted for various selling systems regardless of the type of product that is sold.

1-7. (canceled)

8. An electronic data selling system comprising:
a storage medium storing purchase information concerning electronic data that a buyer desires to purchase; and
an electronic data selling device configured to read the purchase information from the storage medium, provide the electronic data designated by the purchase information to the buyer, transfer a purchase record of the electronic data to the storage medium, and restrict future sales of the electronic data based on the content of the purchase record, the electronic data selling device comprising an operation unit configured to allow the buyer to manually designate a electronic data to be purchased other than the electronic data designated by the purchase information stored on the storage medium.

9. An electronic data selling system comprising:
a storage medium storing purchase information concerning electronic data that a buyer desires to purchase; and
an electronic data selling device configured to read the purchase information from the storage medium, provide the electronic data designated by the purchase information to the buyer, transfer a purchase record of the electronic data to the storage medium, and restrict future sales of the electronic data based on the content of the purchase record, the electronic data selling device comprising an operation unit configured to allow the buyer to manually change the purchase information stored on the storage medium.

10. An electronic data selling device, comprising:
a purchase information reading unit configured to read purchase information concerning electronic data that a buyer desires to purchase from a storage medium;
an electronic data supply unit configured to provide the buyer with the electronic data designated by the purchase information; and
an operation unit configured to allow the buyer to manually designate electronic data to be purchased other than the product electronic data designated by the purchase information stored on the storage medium.

11. An electronic data selling device, comprising:
a purchase information reading unit configured to read purchase information concerning electronic data that a buyer desires to purchase from a storage medium;
an electronic data supply unit configured to provide the buyer with the electronic data designated by the purchase information; and
an operation portion configured to allow the buyer to manually change the purchase information stored on the storage medium.
